(19) United States
(12) Patent Application Publication
(10) Pub. No.: US 2007/0028836 A1
(43) Pub. Date: Feb. 8, 2007

(54) Apparatus for applying an adhesive substance to a fabric strip

(75) Inventor: Giovanni Cartabbia, Palazzolo sull'Oglio (BRESCIA) (IT)

Correspondence Address: HEDMAN & COSTIGAN P.C., 1185 AVENUE OF THE AMERICAS, NEW YORK, NY, 10036, US

(73) Assignee: MACPI-PRESSING DIVISION S.p.A.

(21) Appl. No.: 11/443,654

(22) Filed: May 31, 2006

(30) Foreign Application Priority Data
Jul. 25, 2005 (IT) MI2005A 001433

(51) Int. Cl. B05C 1/00

(52) U.S. Cl. 118/200

(57) ABSTRACT

An apparatus for applying and adhesive substance to a fabric strip comprises a supporting framework provided for supporting one or more adhesive tape coil constituted by a paper support supporting an adhesive substance, and at least a textile fabric support coil or bobbin, and transfer means for transferring the adhesive substance from the paper support therefor to the fabric support at one or more sides thereof.

### BACKGROUND OF THE INVENTION

The present invention relates to an apparatus for applying an adhesive substance to a fabric strip.

In order to stabilize the edge of a fabric piece to be used for making cloth articles of manufacture, to prevent the fabric from ragging or being damaged at the edge thereof, a lot of different systems, such as an application of an adhesive strip, are conventionally used.

Such a stabilizing system has been found as greatly advantageous, since it allows the fabric edge to be properly finished, without using seams or the like.

Moreover, the application of an adhesive strip allows to perform the fabric finishing operation without altering the resilient characteristics of the fabric and auxiliary materials.

### SUMMARY OF THE INVENTION

Accordingly, the aim of the present invention is to provide an apparatus for making adhesive strips of any desired types.

Within the scope of the above mentioned aim, a main object of the invention is to provide such an apparatus which is adapted to transfer either one or two adhesive strips from a paper support to a textile support, at either one or the other or both faces thereof.

Another object of the present invention is to provide such an apparatus allowing to remove exclusively the paper support if the adhesive substances has been applied to the textile or fabric support at one of the faces thereof.

Yet another object of the present invention is to provide such an apparatus which is operatively very flexible, and which, in particular, can be applied to a lot of different types of automatic machines for processing and making cloth articles of manufacture.

According to one aspect of the present invention, the above mentioned aim and objects, as well as yet other objects, which will become more apparent hereinafter, are achieved by an apparatus designed for applying an adhesive substance to a fabric strip, characterized in that said apparatus comprises a supporting framework adapted to support one or more paper supported adhesive coils and at least a fabric support coil, and transfer means for transferring an adhesive substance from the paper support therefor to said fabric or textile support on one or more sides thereof.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a side elevation view schematically showing the apparatus according to the invention in a configuration thereof for applying an adhesive substance only on a side of a textile or fabric support;

FIG. 2 is a further side elevation view schematically showing the apparatus according to the present invention in a configuration thereof for applying an adhesive substance on two sides of a fabric support;

FIG. 3 is a perspective view, showing a transfer diagram for transferring an adhesive substance from a paper support to a fabric support therefor;

FIG. 4 is a further perspective view, showing a transfer diagram for transferring an adhesive substance from two coaxial paper supports to a fabric support;

FIG. 5 is a further perspective view showing a transfer diagram for transferring an adhesive substance from two paper supports, on discrete coils or bobbins, to a fabric support; and

FIG. 6 is yet another perspective view showing an operating diagram of the apparatus including a single textile support with a side thereof applied with an adhesive substance and protected by a paper material.

### DESCRIPTION OF THE PREFERRED EMBODIMENTS

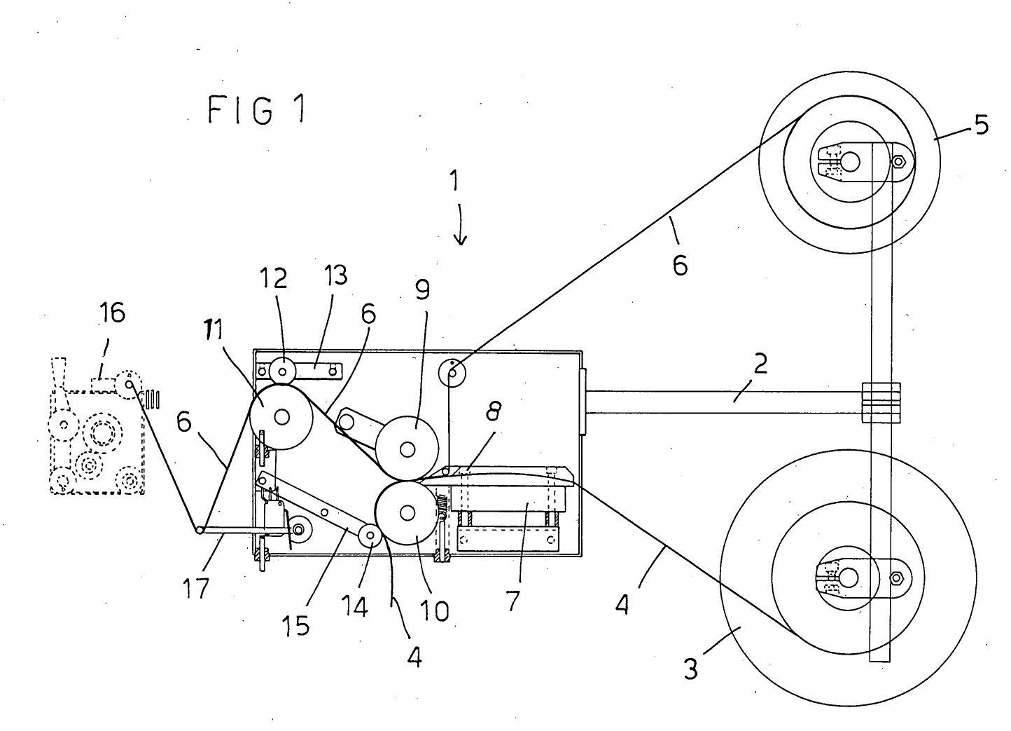

With reference to the number references of FIG. 1, the apparatus according to the invention, which has been generally indicated by the reference number 1, comprises a tape or web supporting framework 2, designed for supporting a bobbin 3 constituted by an adhesive substance supported on a paper support 4, and a fabric or textile material 6 supporting coil or bobbin 5.

The paper support 4 is supplied to a heating plate 7 including interexchageable transfer guides 8 arranged upstream of an adjustable-pressure transfer wheel 9 operating in abutment against a bottom wheel 10.

The textile or fabric support is operatively driven by two timed entraining or driving wheels 10 and 11.

More specifically, the wheel 11 operates against a small wheel 12 associated with a pressure lever 13 for adjusting the driving of the textile or fabric support 6.

The paper support 4, in turn, is driven through the bottom wheel 10, operating against a cooperating bottom small wheel 14 associated with a pressure lever 15 for adjusting the paper entrainment or driving.

At said bottom wheel 10 a paper support drawing device is provided, the paper support being disposed of after having transferred the adhesive substances to the fabric or textile support 6.

Said fabric support 6, after the application of the adhesive substance thereto, will enter a pulling or tension device 16, by passing through a swinging roller 17 for controlling the textile fabric material 6 loop.

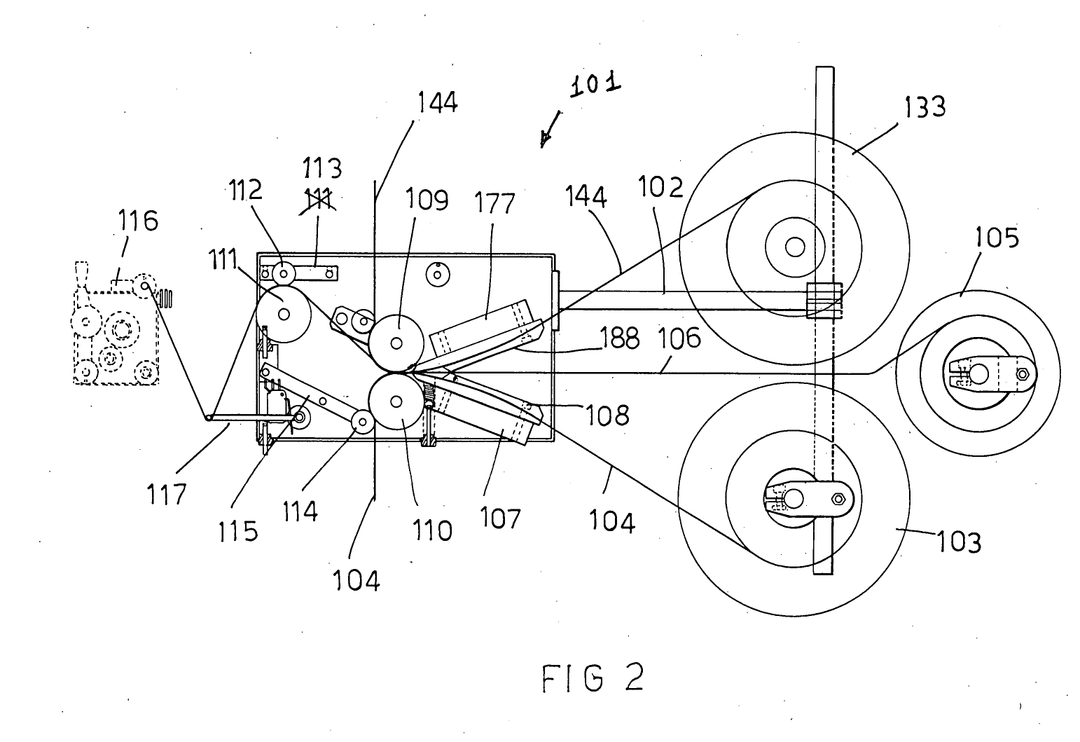

The apparatus shown in FIG. 2 allows to transfer an adhesive substance coming from two discrete and independent paper supports.

With reference to FIG. 2, the apparatus 101 comprises a framework support 102, designed for supporting two bobbins or coils, respectively indicated by the reference numbers 103 and 133, each for a paper supported adhesive substance, as respectively indicated by 104 and 144, and a textile or fabric support 106 coil or bobbin 105.

The first paper support 104 is fed to a first heating plate 107 including interexchangeable transfer guides 108 arranged upstream of a transfer wheel 109, with an adjustable pressure, operating in abutment against a bottom wheel 110.

The second paper support 144 is fed to a first heating plate 177, including interexchangeable transfer guides 188, arranged upstream of the adjustable pressure transfer wheel 109, operating in abutment against the bottom wheel 110.

The driving of the textile or fabric support 106 is carried out by a driving wheel 111, operating in abutment against a small wheel 112 associated with a pressure lever 113 for adjusting the driving or displacement of the fabric support 106.

The driving of the paper supports 104 and 144 is performed through the bottom wheel 110, operating in abutment against a bottom small wheel 114 associated with a pressure lever 115 for adjusting the paper material entrainment.

At the bottom wheel 110 is provided a drawing or suction device for drawing the paper support 104 which is disposed of after having transferred the adhesive substance to the fabric support 106.

The second paper support 144 is disposed of through a second drawing device arranged at the transfer wheel 109.

More specifically, the fabric support 106, with the adhesive substance applied thereto, enter a pulling or tension device 116, by passing through a swinging roller 117 controlling the loop of the fabric support 106.

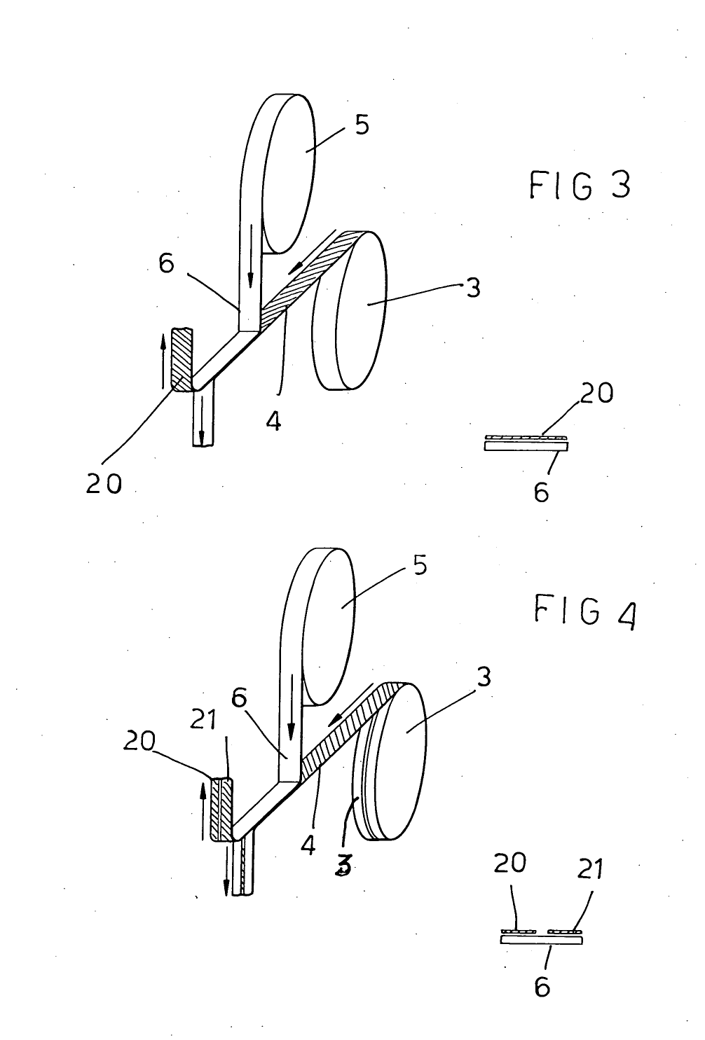

FIGS. 3-6 show possible operating diagram for applying the adhesive substance to the fabric support by the apparatus according to the invention.

More specifically FIG. 3 shows an application diagram, which can be carried out through the apparatus 1, in which an adhesive layer 20 is applied on a side of the fabric support 6.

FIG. 4 shows a further application diagram to be performed by the apparatus 1, in which two adhesive layers 20 and 21, coming from the same paper supports 4, are applied on a side of the fabric support 6.

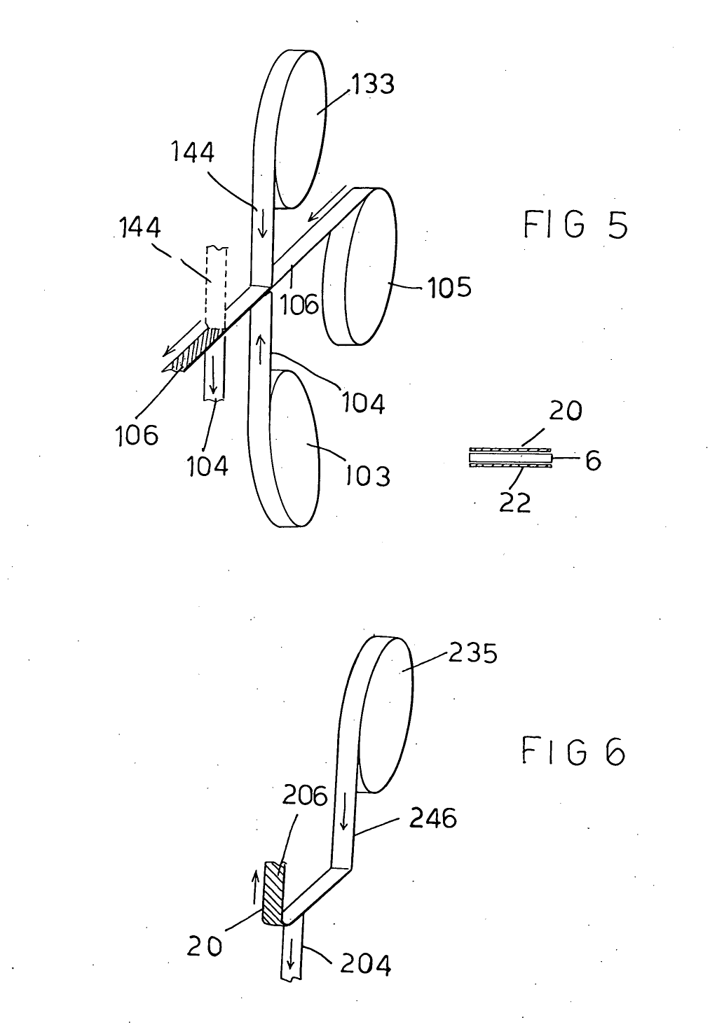

FIG. 5 shows a further application diagram to be performed by the apparatus 101, in which two adhesive layers 20 and 22, each coming from a respective paper support 104 and 144, are applied on two faces or sides of the textile fabric 106.

FIG. 6 shows yet another application diagram to be performed by the apparatus 1, in which an adhesive layer 20 is arranged between a fabric support 206 and a paper support 204, said supports forming together a composite support 246 coming from a single coil or bobbin 235.

By the apparatus according to the present invention, the paper support 204 is removed while leaving exposed the adhesive substance 20 on the textile support 206.

In this connection, it should be pointed out that the adhesive substance applied on an adhesive strip can form either one or more continuous layers or it can be applied according to a point by point pattern thereby providing a grid configuration.

It has been found that the invention fully achieves the intended aim and objects.

In fact, the invention has provided an apparatus adapted to supply a textile or fabric support, including one or more heated adhesive layers, ready for use in a finishing machine for finishing a cloth article of manufacture.

Advantageously, the apparatus according to the invention operates in an electropneumatic manner, and allows to transfer either one or two adhesive strips from a paper support to a fabric support, at one or two sides, and moreover allows to remove only the paper support, if the adhesive substance has been already applied to the fabric support, at one or two sides thereof.

The subject apparatus can comprise moreover a support for assembling it on a finishing machine for performing finishing operations on cloth articles of manufacture, and can use a built-in control panel.

Moreover, the subject apparatus is designed to provide the possibility of interexchanging transfer guides for transferring webs or tapes having a width from 6 to 40 mm.

The heating means included in the apparatus can be programmed with a temperature storing capability.

In practicing the invention, the used materials, as well as the contingent size and shapes, can be any, depending on requirements and the status of the art.

1. An apparatus designed for applying an adhesive substance to a fabric strip, characterized in that said apparatus comprises a supporting framework adapted to support one or more paper supported adhesive coils and at least a fabric support coil, and transfer means for transferring an adhesive substance from the paper support therefor to said fabric or textile support on one or more sides thereof.

2. An apparatus according to claim 1, characterized in that said paper support is supplied to a heating plate including interexchangeable transfer guides, arranged upstream of an adjustable pressure transfer wheel, operating in abutment against a bottom wheel.

3. An apparatus according to claim 1, characterized in that said fabric support is driven by a driving wheel operating in abutment against a further small wheel associated with a pressure lever, for adjusting the driving of the fabric support.

4. An apparatus according to claim 1, characterized in that said paper support is driven through a bottom wheel operating in abutment against a further bottom small wheel, associated with a pressure lever for adjusting the driving of the paper support.

5. An apparatus according to claim 4, characterized in that, at said bottom wheel, a paper material support sucking device is arranged, said paper material support being disposed of after having transferred the adhesive material to the textile support.

6. An apparatus according to claim 1, characterized in that said textile support, after having applied said adhesive material thereto, is supplied to a tensioning device, by causing said textile support to pass through a textile support loop control swinging element.

7. An apparatus according to claim 1, characterized in that said apparatus allows adhesive material coming from two separated and independent paper material supports, to be transferred.

8. An apparatus according to claim 1, characterized in that said supporting frame is designed for supporting two bobbins, each for an adhesive material on a paper support and for a textile support material.

9. An apparatus according to claim 1, characterized in that said first paper material support is supplied to a first heating plate, including interexchangeable transfer guides, arranged upstream of an adjustable pressure transfer wheel operating in abutment against a bottom wheel.

10. An apparatus according to claim 1, characterized in that said second paper material support is fed to a first heating plate, including interexchangeable transfer guides, arranged upstream of a transfer wheel, with adjustable pressure, operating in abutment against a bottom wheel.

11. An apparatus according to claim 10, characterized in that said paper support is driven through said bottom wheel operating in abutment against said bottom further small wheel associated with a pressure lever for adjusting the paper support driving.

12. An apparatus according to claim 11, characterized in that the second paper support is disposed of by a second drawing or suction device arranged at said transfer wheel.

13. An apparatus according to claim 1, characterized in that an adhesive layer is arranged between a fabric support and a paper support, said fabric support and paper support forming in cooperation with one another a composite support delivered from a single bobbin.

14. An apparatus according to claim 1, characterized in that said apparatus further comprises a supporting assembly for allowing said apparatus to be assembled on a finishing machine for finishing cloth articles of manufacture, and including a built-in control panel built-in in said finishing machine.

15. An apparatus according to claim 1, characterized in that said apparatus comprises a plurality of interexchangeable guides for transferring strips having a width from 6 to 40 mm.

16. An apparatus according to claim 1, characterized in that the adhesive substance applied on said adhesive strip comprises one or more continuous adhesive layers or can be applied according to a point by point pattern, thereby providing a pattern grid arrangement.

17. An apparatus according to claim 1, characterized in that said apparatus comprises programmable heating means with a heating temperature capability store.
